(19) United States
(12) Patent Application Publication
(10) Pub. No.: US 2016/0123915 A1
(43) Pub. Date: May 5, 2016

(54) PHOTOELECTROCHEMICAL ASSAY APPARATUS FOR DETERMINING CHEMICAL OXYGEN DEMAND

(71) Applicant: CHAOYANG UNIVERSITY OF TECHNOLOGY, Taichung City (TW)

(72) Inventor: WEN-YU WANG, Taipei City (TW)

(21) Appl. No.: 14/699,517

(22) Filed: Apr. 29, 2015

(30) Foreign Application Priority Data
Nov. 5, 2014 (TW) 103138444

(51) Int. Cl. G01N 27/30

(52) U.S. Cl. CPC G01N 27/30

(57) ABSTRACT

The present disclosure discloses a chemical oxygen demand detection apparatus. In the apparatus, a working electrode, which is included TiO₂ nanotube arrays electrode between 1800-2500 nm in length, is excited the photoelectrocatalysis reaction thereon by a single wavelength UV-LED module and an electrochemical analysis module. A fixing holder is configured to fix a three-electrode module and the UV-LED module to immerse in sample. An electrochemical analysis module, which electrical connect to the three-electrode module, is configured to receive a time-dependent current signal and integrates time-dependent current signal to get total electric charge, and generates a detecting result to indicate chemical oxygen demand value of sample.

### CROSS-REFERENCE TO RELATED APPLICATION

This application claims the benefit of Taiwan Patent Application No. 103138444, filed on Nov. 5, 2014, the disclosure of which is incorporated herein in its entirety by reference, in the Taiwan Intellectual Property Office.

### BACKGROUND OF THE INVENTION

1. Field of the Invention

This invention relates to photoelectrochemical assay apparatus for determining chemical oxygen demand. In particular, the invention relates to a photoelectrochemical assay apparatus using titanium dioxide nanotube arrays electrode as a working electrode for determining chemical oxygen demand.

2. Description of the Related Art

Standard analytical methodologies for the determination of aggregate properties such as oxygen demand in water are biochemical oxygen demand (BOD) and chemical oxygen demand (COD). BOD involves the use of heterotrophic microorganisms to oxidize organic material and thus estimate oxygen demand. COD uses strong oxidizing agents, such as dichromate or permanganate, to oxidize organic material. BOD analysis is carried out over five days and oxygen demand determined by titration or with an oxygen probe. COD measures dichromate or permanganate depletion by titration or spectrophotometry. However, both BOD and COD methodologies have serious technological limitations.

First, time consumptions of both BOD and COD are about 3-4 hours.

Secondly, the adding of the mercury sulfate may provide mercury-containing wastewater and have secondary pollution of the environment.

Thirdly, the agents is adding to exclude interference such as pH value, chloride ions, cyanide ions, hexavalent chromium ions, hydrogen peroxide, heavy metal and toxic chemicals.

Fourthly, the temperature adapting step or dilution step may provide to solve the deviation form oversaturation oxygen in the sample water.

The method of determining chemical oxygen demands in prior art is not satisfy to the industry process requirement and the environment friendly. Therefore, it is a primary issue to development a technology of determining chemical oxygen demand rapidly and reliably.

In prior art, the photocatalytic oxidation approach for COD determination utilizes on working electrode as photocatalyst. The principle of the approach is that, a semiconductor is configured as an electrode and is Illuminated by UV light, and photons whose energy is equal to or greater than the band-gap energy, will result in promotion of an electron from the valence band to the conduction band and form an electron-hole pair which has powerful oxidizers, and the organic compound is oxidized easily by the hold on the surface of the electrode, therefore, the electron separated from electron-hold pair transfer to the auxiliary electrode to generation the current. A detecting result is obtained from the current per unit time or the total charge during the reaction time to a COD value as the equivalent below:

Q=∫idt=nFN=nFVC

N=number of moles of analyte in the sample,
n=number of electrons transferred during the photo-electrochemical degradation,
F=Faraday constant,
V=sample volume; and
C=analyte concentration.
Given that oxidation by O₂ can be represented as:

O₂+4H⁺+4e⁻→2H₂O

Wherein one oxygen molecule is equivalent to 4 electrons, the measured Q value can be easily converted into an equivalent O₂ concentration (or chemical oxygen demand) value: equivalent O₂ concentration (mole/L)=Q/4FV

The equivalent COD value of the sample can therefore be represented as:

COD (mg/L of O₂)=(Q/4FV)×32000

In above describe shows that the reaction rate of the detecting method depends on the property of the working electrode and the recombination of electron-hold pair. The titanium dioxide, which has high property of oxidation, chemical stability, corrosion-resistance by light illuminating, non-toxic and cheap, is used in the wastewater treatment, water monitoring, air purification, and the like. Therefore, different type of titanium dioxide is used as a catalyst of detecting the chemical oxygen demand in prior art.

However, the xenon lamp is used as a UV light source in prior art, which the filters and shutter is configured to reducing the sample heated by the light source. Before the detecting process, the xenon lamp have to preheat, and covered by shutter until detecting process until detecting process then finished the operation of detection. However is not satisfy for a large number detecting process and the apparatus is also complicated. Therefore, it is a primary issue to development an apparatus which is easy to operate, simpler structure, and may provide short detection time and extend the detection limits of COD value.

### SUMMARY OF THE INVENTION

The present disclosure provides a photoelectrochemical assay apparatus for determining chemical oxygen demand of a water sample, which has advantages of extending the detection limits, requiring less detection time, a relatively simple structure of the apparatus and easily operation.

To achieve the foregoing objective, the present disclosure provides a photoelectrochemical assay apparatus for determining chemical oxygen demand of a water sample, comprise a three-electrode module, comprising a titanium dioxide nanotube arrays electrode, an auxiliary electrode and a reference electrode, a length of nanotube of the titanium dioxide nanotube arrays electrode ranged from 1000 nm to 2500 nm; a light emitting module, spaced apart from the titanium dioxide nanotube arrays electrode by a distance, and configured for radiating a light with single wavelength on the titanium dioxide nanotube arrays electrode to excite photoelectrochemical reaction; a measuring cell, used to fill the water sample to be analyzed; a fixing holder, disposed around the measuring cell to fix the three-electrode module and the light emitting module to be immersed in the water sample; an electrochemical control and measuring module, electrically connected to the three-electrode module and configured for applying a voltage to the titanium dioxide nanotube arrays electrode and receiving a current per unit time from the three-electrode module; and an analysis module, electrically connected to the electrochemical control and measuring module and configured for integrating the current with time to get total electric charge, and deriving a detection result of chemical oxygen demand of the water sample form the total electric charge.

Preferably, the length of nanotube of the titanium dioxide nanotube arrays electrode is ranged from 1800 nm to 2300 nm.

Preferably, the light emitting module includes an UV light emitting diode.

Preferably, a wavelength of the single wavelength light is ranged from 340 nm to 380 nm.

Preferably, an intensity of light from the light emitting module is ranged from 10 mW/cm² to 30 mW/cm².

Preferably, the distance between the light emitting module and the titanium dioxide nanotube arrays electrode is ranged from 0.5 cm to 2.0 cm.

Preferably, the photoelectrochemical assay apparatus further includes an apparatus of applied a stable voltage to titanium dioxide nanotube arrays electrode in a range of 0V to 1V.

Preferably, the photoelectrochemical assay apparatus further includes a power control and adjusting module configured for controlling the intensity of light from the light emitting module.

Preferably, the titanium dioxide nanotube arrays electrode is prepared by performing an anodic oxidation on titanium, and the electrolytes for the anodic oxidation comprising an ammonium fluoride, a hydrogen fluoride, a glycerol or a glycol.

Preferably, the concentration of the glycerol in the electrolytes is ranged from 50 wt % to 80 wt %.

Preferably, the measuring cell comprises a batch reactor or a continuous flow reactor.

Compared with the traditional technology, the present disclosure has following advantages. First, the apparatus having single wavelength UV LED is configured without UV light shutter and filter, and have faster switching, easy to operate and the cost of apparatus is cheaper. Second, comparing with the known in the art, the present disclosure have property of tolerance of chlorine ion in water sample, therefore the COD value of water sample is measured without adding the mercury sulfate into the water sample to inhibited the interference of chlorine ion and reduces the secondary pollution of the environment. Third, according to the result of the COD value of wastewater measured, the apparatus is operated without considering the effect of background of the wastewater, that is, the COD value of the wastewater can be derived by comparing with calibration curve and the detection result.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a schematic view of photoelectrochemical assay apparatus of the present disclosure.

FIG. 2 is the correlation between the theoretical COD concentration of potassium hydrogen phthalate (KHP) and electric charge.

FIG. 3 is the correlation between the theoretical COD concentration of ethanedioic acid and electric charge.

FIG. 4 is the correlation between the detecting time of the theoretical COD concentration of KHP and electric charge.

FIG. 5 is the correlation between the detecting time of the theoretical COD concentration of ethanedioic acid and electric charge.

FIG. 6 is the correlation between the chlorine ion tolerance of detecting the theoretical COD concentration of KHP and electric charge.

FIG. 7 is the correlation between the chlorine ion tolerance of detecting the theoretical COD concentration of ethanedioic acid and electric charge.

FIG. 8 is the correlation between the electric charge result of the industrial wastewater derived by the apparatus in the disclosure and conventional COD method (dichromate method).

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

The titanium dioxide nanotube arrays electrode of the present disclosure is prepared by following steps. After the plate-shaped titanium is washed in the sonicator by acetone, isopropanol and deionized water respectively for 10 minutes, the titanium dioxide nanotube arrays electrode is prepared by performing an anodic oxidation on titanium. That is, the cleaned titanium plate served as an anode and the cleaned platinum plate served as a cathode are immersed into the electrolytes. In the electrolytes, the weight ratio of the glycerol and water in the electrolytes is 6:4 to 8:2 including 0.3 wt % to 1 wt % of ammonium fluoride. Next, under the condition of voltage at 10V to 50V and the temperature of electrolytes at 10° C. to 50° C., the electrolytic process is performed for 1 hr to 4 hr, and the sintering process is then performed at 600° C. for 2 hours to 6 hours. Then, the titanium dioxide nanotube arrays electrode having the length of nanotube ranged from 1000 nm to 2500 nm can be obtained. In other embodiment of the present disclosure, the hydrogen fluoride can be used instead of ammonium fluoride, and the glycol can be used instead of glycerol, but the present disclosure is not limited thereto.

Preferably, the titanium dioxide nanotube arrays electrode having the length of nanotube about 2100 nm can be prepared under the following conditions. In the electrolytes include the 6:4 weight ratio of the glycerol and water and 0.5 wt % of ammonium fluoride, the voltage for electrolytic process is 30 V, the temperature of electrolytes is maintained at 20° C. for 2 hr, and the sintering process is performed at 600° C. for 3 hours.

As a result, in the case in which the weight ratio of the glycerol and water is about 6:4 to 8:2, the nanotube arrays structure on titanium dioxide films can be performed completely. However, in the case in which the weight ratio of the glycerol and water is 1:9, 2:8 or 4:6, the nanotube arrays structure on titanium dioxide films is not performed completely. Because in electrolytes the ratio of glycerol and water may have an effect on the rate of ion exchange and the rate of chemical etching of fluoride ion, well controlling the current density at electroplated process is an important factor for the length of nanotube. Therefore, more water contented in electrolytes may result in a short length or incomplete structure of nanotube; however, when the water content is lower than a predefined value, it is hard to perform a complete nanotube structure.

Therefore, the concentration of glycerol in the electrolytes for preparation of the titanium dioxide nanotube arrays electrode is ranged from 50 wt % to 80 wt %. Preferably, the concentration of glycerol in the electrolytes is 50 wt %, 55 wt %, 60 wt %, 65 wt %, 70 wt %, 75 wt % or 80 wt %.

The titanium dioxide nanotube arrays electrode prepared under the above described condition can have the length of nanotube range from 1000 nm to 2500 nm. Preferably, the length is ranged from 1800 nm to 2300 nm. That is, the length of nanotube of the titanium dioxide nanotube arrays electrode prepared under the above described condition is about 1100 nm, 1200 nm, 1300 nm, 1300 nm, 1400 nm, 1500 nm, 1600 nm, 1700 nm, 1800 nm, 1900 nm, 2000 nm, 2100 nm, 2200 nm, 2300 nm, 2400 nm or 2500 nm.

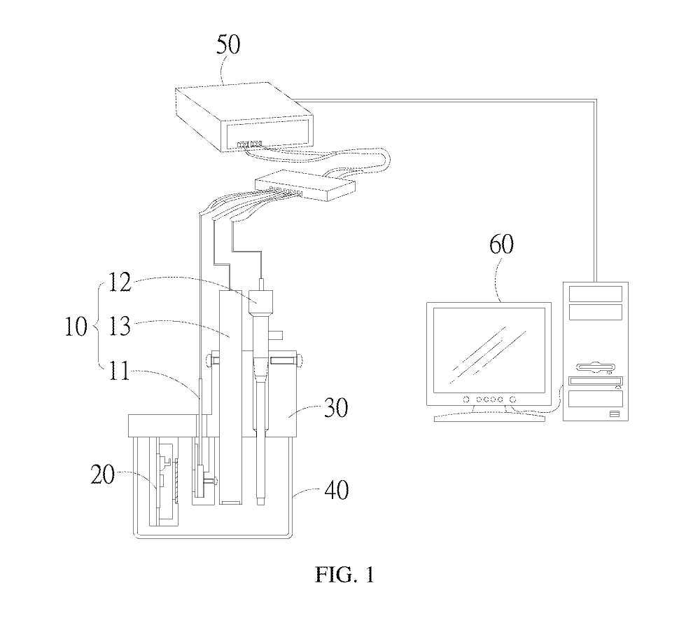

Please refer to FIG. 1 which is a schematic view of photoelectrochemical assay apparatus. The photoelectrochemical assay apparatus includes a three-electrode module 10, a UV light emitting diode 20, a fixing holder 30, a measuring cell 40, an electrochemical control, a measuring module 50 and an analysis module 60. The three-electrode module 10 includes a titanium dioxide nanotube arrays electrode 11, a reference electrode 12, and an auxiliary electrode 13. The titanium dioxide nanotube arrays electrode 11 has a length of nanotube ranged from 1800 nm to 2500 nm.

The titanium dioxide nanotube arrays electrode 11 is excited by the UV light emitting diode 20 and the electrochemical control and measuring module 50, to generate electron-hold pairs which are powerful oxidizers on the surface of the titanium dioxide nanotube arrays electrode 11. The UV light emitting diode 20 of the present disclosure is a light emitting diode with single wavelength, and provides the light having 365 nm of wavelength. The UV light emitting diode 20 may be a micro UV light emitting diode which is spaced apart from the titanium dioxide nanotube arrays electrode 11 by 0.5 cm to 2.0 cm and provides stable intensity radiation on the surface of titanium dioxide nanotube arrays electrode 11 by 0.785 cm² area. The electrochemical control and measuring module 50 is electrically connect with titanium dioxide nanotube arrays electrode 11 and configured for applying a voltage to the titanium dioxide nanotube arrays to inhibit the recombination of electron-hold pairs.

Comparing with the xenon lamp, the light emitting diode used as a light source has advantages of switching faster, outputting with full power immediately after switching, without the shutter, small size, lower energy consumption, without the filter and heating the sample due to the single wavelength. Therefore, the apparatus of the present disclosure has properties of low cost and easy operation.

The titanium dioxide can be excited by a wavelength of the ultraviolet to generate the stable electron-hold pairs. Therefore, the single wavelength of the UV light emitting diode 20 is in a linear range of 340 nm to 380 nm; preferably, the single wavelength of the UV light emitting diode 20 may be 340 nm, 345 nm, 350 nm, 355 nm, 360 nm, 365 nm, 370 nm, 375 nm or 380 nm.

The intensity of the UV light emitting diode 20 may affect the efficient detective. Preferably, the intensity of the UV light emitting diode 20 may be in a linear range of 10 mW/cm² to 30 mW/cm²; preferably, the intensity may be 10 mW/cm², 15 mW/cm², 20 mW/cm², 25 mW/cm² or 30 mW/cm².

The variances in the length and the diameter of the nanotube and in the distance between the light source and the titanium dioxide nanotube arrays electrode 11 may affect the quantity of the current on working electrode. Preferably, in the experiment example of the present disclosure, the distance between the UV light emitting diode 20 and the titanium dioxide nanotube arrays electrode 11 may be in a linear range of 0.5 cm to 2 cm. Preferably, the distance can be 0.5 cm, 0.8 cm, 0.9 cm, 1.0 cm, 1.2 cm, 1.5 cm or 2.0 cm.

The electrochemical control and measuring module 50 is configured for providing a stable voltage to titanium dioxide nanotube arrays electrode 11 to inhibit the recombination of electron-hold pairs. The voltage may be in a linear range of 0 V to 1 V. Preferably, the voltage is 0.1 V, 0.2 V, 0.3 V, 0.4 V, 0.5 V, 0.6 V, 0.7 V, 0.8 V, 0.9 V or 1 V.

Preferably, the intensity of light source, the distance between the light source and the titanium dioxide nanotube arrays electrode 11, and the voltage provided form the electrochemical control and measuring module 50 to the titanium dioxide nanotube arrays electrode 11 can be adjusted from a linear calibration curve.

The fixing holder 30 may be resistant material such as polypropylene or fluon, and fix the three-electrode module 10 and the light emitting module to be immersed in the water sample. The electrochemical control and measuring module 50 is electrically connected to the three-electrode module 10 and configured for receiving a current per unit time from the three-electrode module 10. The analysis module 60 is electrically connected to the electrochemical control and measuring module 50 and configured for integrating current with time to obtain the total charge and deriving a detection result of chemical oxygen demand of the water sample form the total charge.

Preferably, the measuring cell 40 may be a batch reactor or a continuous flow reactor if necessary.

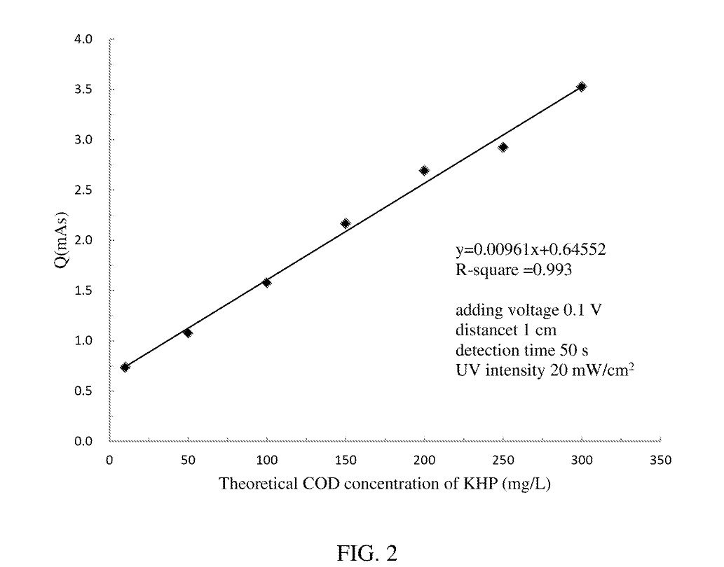

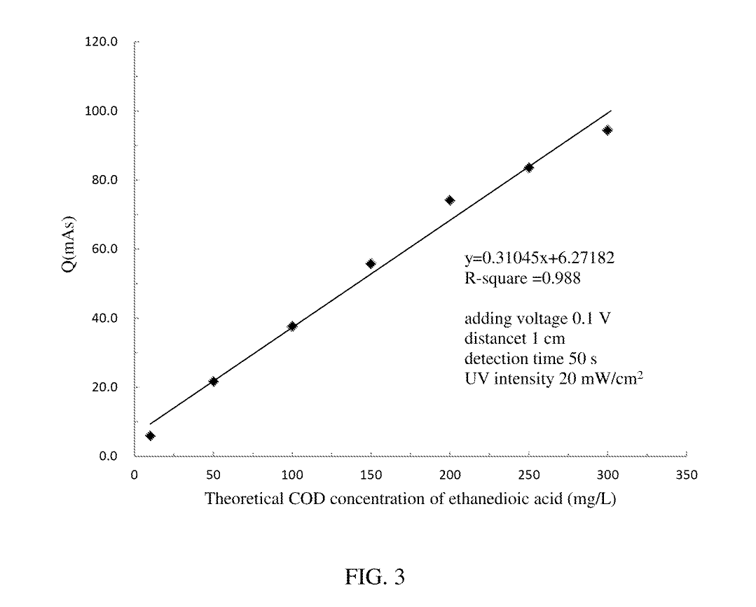

Please refer to FIG. 2 and FIG. 3. FIG. 2 is the correlation between the theoretical COD concentration of potassium hydrogen phthalate (KHP) and electric charge and FIG. 3 is the correlation between the theoretical COD concentration of ethanedioic acid and electric charge. The detection is performed under the conditions below. The KHP and the ethanedioic acid is used as a standard, the distance of titanium dioxide nanotube arrays electrode 11 and UV light emitting diode 20 is fixed at 1 cm, the intensity is 20 mW/cm², the bias voltage applied to the working electrode is 0.1 V, and detected time is 50 seconds. In the Figs, the vertical axis is total charge (mAs), and the horizontal axis is theoretical COD concentration of standard (mg/L). As a result, the correlation coefficient of the theoretical COD concentration of KHP and ethanedioic acid with total charge between the concentration 10 mg/L to 300 mg/L is 0.993 and 0.988 respectively.

The preparation conditions of the titanium dioxide nanotube arrays by anodic oxidation, is not only based on the applied voltage of electrolytically, the temperature controlled of electrolytes, the electrolytically times, but also based on controlling for the pH values of electrolytes and the concentration of fluoride ion in the electrolytes. The length of nanotube of titanium dioxide nanotube arrays of the present disclosure is about 2100 nm, the diameter of titanium dioxide is 180 nm. In a case in which the titanium dioxide is used as photoelectrochemical catalysts, a titanium dioxide having longer length can provide more reaction area and extend the detection limits of COD value.

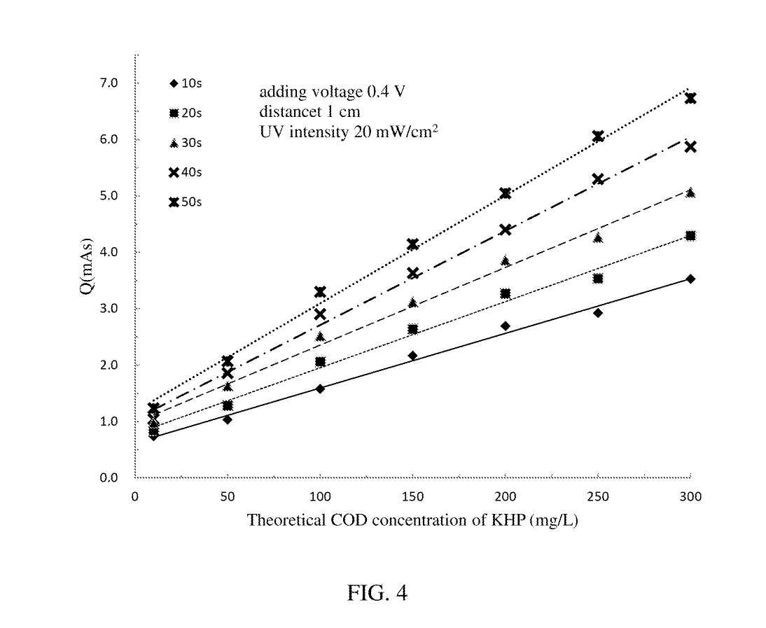

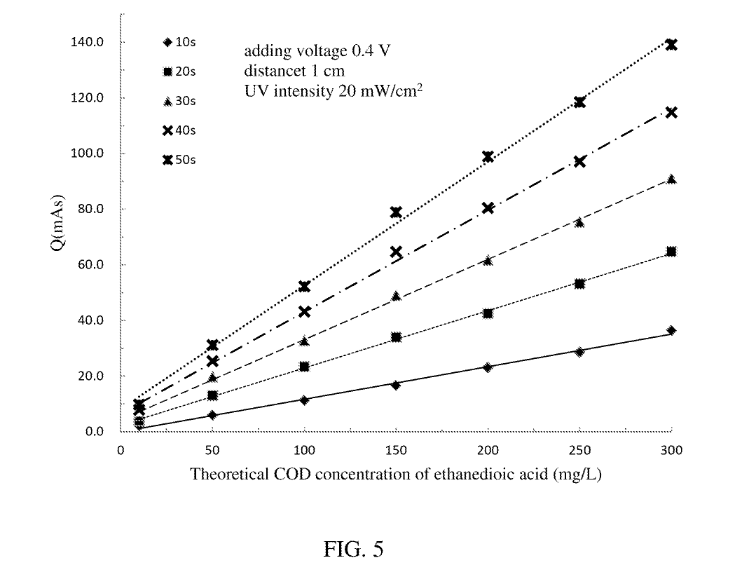

Please refer to FIG. 4 and FIG. 5. FIG. 4 is the correlation between the detecting time of the theoretical COD concentration of KHP and electric charge, and FIG. 5 is the correlation between the detecting time of the theoretical COD concentration of ethanedioic acid and electric charge. The detection is performed under the conditions below. the KHP and the ethanedioic acid is used as a standard, the distance of titanium dioxide nanotube arrays electrode 11 and UV light emitting diode 20 is fixed at 1 cm, the intensity is 20 mW/cm², voltage applied to the working electrode is 0.4 V, and detection is performed for 10 seconds to 50 seconds. In Figs, the vertical axis is total charge (mAs), the horizontal axis is theoretical COD concentration of standard (mg/L). As a result, the correlation coefficient of the theoretical COD concentration of KHP and ethanedioic acid with total charge detected for 10 seconds to 50 seconds is in a range from 0.991 to 0.995. The results show that the rate of organic compound in water exhausted through the photoelectrochemical reaction and the concentration of COD value is directly proportion within 10 seconds, so the detection time may be 10 seconds.

The xenon lamp is used as the UV light source in prior art, and filters and shutter are also required. Therefore, before the detection process, the xenon lamp has to preheat in advance and covered by shutter, and then the shutter is opened during the detection process. During the detecting process, the working electrode is radiated by UV light to generate electron-hold pairs on the surface thereof, and the organic compound is oxidized easily by the holes on the surface of the working electrode, so the electrons separated from electron-hold pairs are transferred to the auxiliary electrode to generate the current. The value of total charge also depends on the time of photochemical reaction on the surface of working electrode. Preferably, the detection is about 45 seconds.

According to the result of the present disclosure, the photoelectrochemical reaction equilibrium completes within 10 seconds, and value of total charge is linearly increased within the 50 seconds later. That is, the sample spread on the surface of the titanium dioxide nanotube arrays electrode 11 may contact uniformly with the surface of the electrode, and the reaction rate and the concentration of COD value is directly proportion, so the direct proportion of the KPH and ethanedioic acid having different rates of oxidation are not affected respectively by the detection time. As a result, the COD value of the sample may be obtained within 10 seconds of detecting time, the present disclosure has advantages of avoiding the sample from being heated by the light source reaction during detection, and reducing the other reaction generated from the variation of temperature, and the likes.

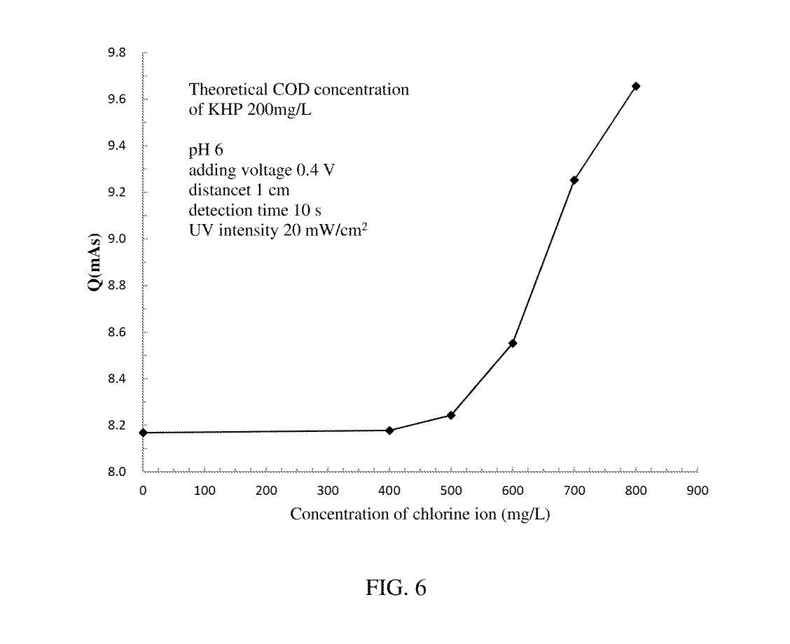

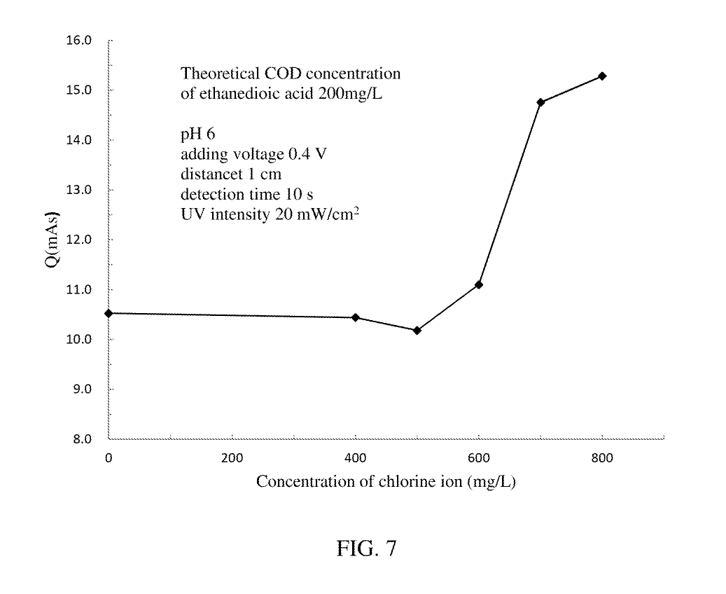

Please refer to FIG. 6 and FIG. 7. FIG. 6 is the correlation between the chlorine ion tolerance of detecting the theoretical COD concentration of KHP and electric charge, and FIG. 7 is the correlation between the chlorine ion tolerance of detecting the theoretical COD concentration of ethanedioic acid and electric charge. The KHP and the ethanedioic acid are used as standards, the theoretical COD concentration of the standard is 200 mg/L in pH 6, and the concentration of chlorine ion in standard is 400 mg/L to 800 mg/L by adding the sodium chlorine in standard. The detection is performed under the conditions below. The distance of titanium dioxide nanotube arrays electrode 11 and UV light emitting diode 20 is fixed at 1 cm, the intensity is 20 mW/cm², voltage applying to the working electrode is 0.4 V, and detection time is 10 seconds. In Figs, the vertical axis is total charge (mAs), and the horizontal axis is the concentration of chlorine ion (mg/L). As a result, the deviation value of the total charge of the KHP and ethanedioic acid is 18.2% and 45.2% respectively at the 800 mg/L of chlorine ion, and is 4.5% and 5.5% respectively at the 600 mg/L of chlorine ion, that is, the total charge of the KHP and ethanedioic acid is not influenced under the 600 mg/L of chlorine ion.

The chlorine ion is main interfering substance in determination of COD in potassium dichromate colorimetric (COD_{Cr}) method. To solve this problem, the adding of mercury sulfate into water sample for inhibiting the chlorine ion is necessarily in prior art. However, the mercury sulfate causes the pollution of the environment, and has poor effect in a water sample having high concentration of chlorine ion but low COD value. According to the result of the present disclosure, compared with the detection method in prior art, the photoelectrochemical assay apparatus of the present disclosure have a property of tolerance to chlorine ion, and may reduce the secondary pollution of the environment.

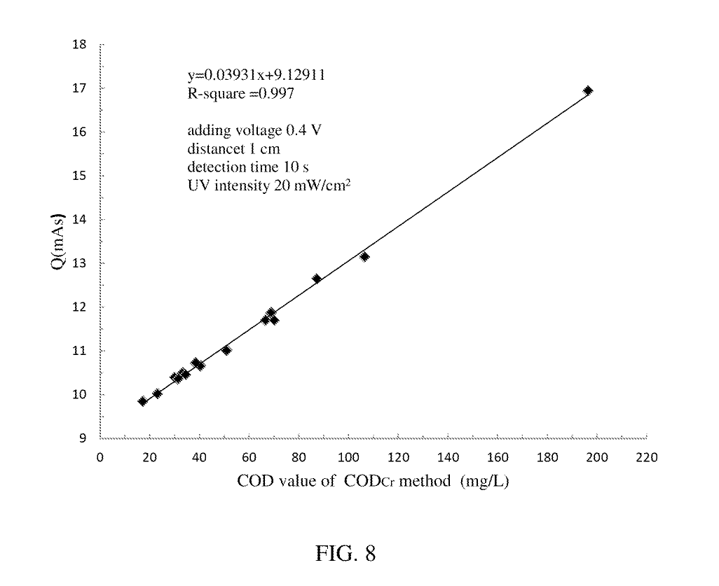

Please refer to FIG. 8 which is the correlation between the electric charge result of the industrial wastewater derived by the apparatus in the disclosure and conventional COD method (COD_{Cr} method). In this embodiment, 15 wastewater samples from different industries (steel industries, surface treatment industries, painting industries, electroplating industries, chemical industries, paper industries, pharmaceutical industries, and food industries) are detected by COD_{Cr} method and photoelectrochemical reaction method respectively. The detection is performed under the conditions below. The distance of titanium dioxide nanotube arrays electrode 11 and UV light emitting diode 20 is fixed at 1 cm, the intensity is 20 mW/cm², voltage applying to the working electrode is 0.4 V, and detection time is 10 seconds. In FIG. 8, the vertical axis is total charge (mAs), and the horizontal axis is the COD value obtained by COD_{Cr} method (mg/L). In this condition, the detection range of the photoelectrochemical assay apparatus of the present disclosure is ranged from 0.6 mg/L (detection limits) to 300 mg/L (upper correction limits).

TABLE 1

| | Q value | COD_{Cr} vlaue | COD value |
|---|---|---|---|
| item | (mAs) | (mg/L) | (mg/L) |
| Sample 1 | 10.02633 | 23.12 | 20.67 |
| Sample 2 | 9.85156 | 17.24 | 16.04 |
| Sample 3 | 10.39925 | 30.01 | 30.55 |
| Sample 4 | 10.36283 | 31.28 | 29.59 |
| Sample 5 | 10.50001 | 33.18 | 34.87 |
| Sample 6 | 10.65969 | 40.37 | 37.45 |
| Sample 7 | 10.4644 | 34.43 | 32.28 |
| Sample 8 | 10.72797 | 38.44 | 39.26 |
| Sample 9 | 11.01428 | 51.00 | 46.84 |
| Sample 10 | 11.70001 | 66.52 | 65.40 |
| Sample 11 | 11.70215 | 70.11 | 65.07 |
| Sample 12 | 11.87701 | 68.80 | 69.70 |
| Sample 13 | 12.64982 | 87.25 | 90.17 |
| Sample 14 | 13.1484 | 106.40 | 103.38 |
| Sample 15 | 16.9422 | 196.32 | 203.87 |

Q value is obtained from the Photoelectrochemical method.
COD_{Cr} value is obtained from the dichromate method.
COD value is obtained from Q value translated by equation (1) blow.

Please refer to table 1 and FIG. 8. As a result, the COD value of the industrial wastewater is ranged from about 20 mg/L to 196 mg/L detected by COD_{Cr} method, and the total charge detected by photoelectrochemical assay apparatus is corrected as the following equation to obtain the COD value:

Total charge (mAs)=0.3931×value of potassium dichromate (mg/L)+9.12911 Equation (1):

By using the photoelectrochemical assay apparatus of the present disclosure, a COD value of the unknown sample may be obtained through the total charge thereof calculated with the calibration curve according to the wastewater and the COD_{Cr} value in the above described. As a result, the calibration curve having a property of correlation coefficient (R²=0.997) shows that the photoelectrochemical assay apparatus of the present disclosure can be suitably operated for detecting the COD value of effluent, process water, or public water.

In COD_{Cr} method in prior art, overdose of the potassium dichromate is added into sample to completing reaction with organic compound, then the ferrous ammonium sulfate is added to reduce the residual potassium dichromate to obtain the COD value. The detection method of the present disclosure, the value of the water used as a background is about 0.1% of the total value. Therefore, the COD value is obtained without considering the effecting of background due to having low noise of background, that is, the detection result of sample is corresponding to the COD value directly. In the other words, the detection value obtained by the present disclosure is not affected by background, and the detection value can also be observed in short detection time.

Compared with the apparatus of the present disclosure, in the photoelectrochemical assay apparatus for determining chemical oxygen demand in prior art, the COD value is obtained by integrating the current with time and then subtract the integrated result form the background. The correlation coefficient of the value between COD_{Cr} method and the detecting method of the photoelectrochemical assay apparatus is 0.973, and the detecting range of the wastewater is not as broad as the photoelectrochemical assay apparatus of the present disclosure. According to the principle of the photoelectrochemical reaction application in this present disclosure, the advantages of the photoelectrochemical assay apparatus of the present disclosure is depended on the cooperation of adapting the intensity, the applied voltage on working electrode, and the length of titanium dioxide nanotube arrays electrode.

In conclusion, compared with the COD detecting method in prior art, the photoelectrochemical assay apparatus of the present disclosure also have some advantages.

In prior art, the detecting method which is used the rapid test kit based on colorimetric method for COD determining, has limitation of incomplete reaction with sample or ion matrix interference, and the detect results of the sample is affected seriously.

In prior art, there is other detecting method in which a heating process is performed by adding the test kit based on colorimetric method for COD determination into the sample. However, the time cost of such detecting method is as long as the dichromate method. Compared with the dichromate method in which the COD value is obtained by titration, the colorimetric method described below has low degree of accuracy.

In prior art, there is also a detection method of continuous monitoring and detecting by multiple wavelengths, but such method has a limit of being easily interfered by ion matrix interference, and the lens and value of optical path of the apparatus easily failed because of being contaminated by the dirt in the wastewater.

In prior art, there is other detection method in which an automatic continuous monitoring apparatus for dichromate method including a quantitative pump, a multi-way switching valve and a photometer is used. However, such method has a limit of ion matrix interference, and the quantitative pump and the multi-way switching valve easily fail because of being blocked the dirt in the wastewater.

The surface of the working electrode of the present disclosure, which is used as a catalysts reacting with the organic compound, has a property of self-cleaning, so the surface of the working electrode may not be contaminated with the dirt in the water, and the detection result may not be affected. As a result, after 900 standards are detected in 30 days, the value of reproducibility is 0.9%, and the structure of the surface of the working electrode is not damaged. The photoelectrochemical technology of the present disclosure is the advanced oxidation process, and the reducing potential of the oxyhydrogen free radical (2.80 V) generated form the process is higher than ozone (2.08 V), hydrogen peroxide (1.77 V), chlorine ion (1.36 V), and only lower than the fluoride ion (3.06 V). That is, the photoelectrochemical technology of the present disclosure has a nice property of oxidation to oxidize almost organic compounds in the wastewater.

In prior art, the photocatalysts reaction is used to detect the total charge of the wastewater to obtain the COD value, but has a low efficiency of generating proton by photocatalysts reaction due to easy recombination of electron-hold pair, and a small reaction area of photocatalysts nanoparticle films. In the case in which the wastewater includes a component of non-oxidation tendency, the concentration of oxyhydrogen free radical is not enough to oxidize in high COD contained wastewater, and result in a non-liner calibration curve obtained in high COD contained wastewater.

In the photoelectrochemical reaction of the present disclosure, a small voltage is applied to inhibit the recombination of electron-hole pair, and a higher surface area on the nanotube structure is provided to maintain a high oxidation activity by high generation efficiency of oxyhydrogen free radical. In the case in which the wastewater includes a component of non-oxidation tendency, as a result, a liner calibration curve can be obtained from low COD contained wastewater to high COD contained wastewater.

The light emitting diode used as a light source of the present disclosure, has a property of switching faster, outputting with full power immediately after turning-on, and has an advantage of small size, without shutter between light source and working electrode due to short-time switched, lower energy consumption, and without a filter to exclude the infrared which heat the sample during detection. Therefore, the apparatus have properties of low cost and easy operation.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A photoelectrochemical assay apparatus for determining chemical oxygen demand of a water sample, comprising:
a three-electrode module, comprising a titanium dioxide nanotube arrays electrode, an auxiliary electrode and a reference electrode, a length of nanotube of the titanium dioxide nanotube arrays electrode ranged from 1000 nm to 2500 nm;
a light emitting module, spaced apart from the titanium dioxide nanotube arrays electrode by a distance, and configured for radiating a light with single wavelength on the titanium dioxide nanotube arrays electrode to excite photoelectrochemical reaction;
a measuring cell, used to fill the water sample to be analyzed;
a fixing holder, disposed around the measuring cell to fix the three-electrode module and the light emitting module to be immersed in the water sample;
an electrochemical control and measuring module, electrically connected to the three-electrode module and configured for applying a voltage to the titanium dioxide nanotube arrays electrode and receiving a current per unit time from the three-electrode module; and
an analysis module, electrically connected to the electrochemical control and measuring module, and configured for integrating the current with time to get total electric charge and deriving a detection result of chemical oxygen demand of the water sample form the total electric charge.

2. The photoelectrochemical assay apparatus of claim 1, wherein the light emitting module is an UV light emitting diode.

3. The photoelectrochemical assay apparatus of claim 1, wherein a wavelength of the single wavelength light is ranged from 340 nm to 380 nm.

4. The photoelectrochemical assay apparatus of claim 1, further comprising a power control and adjusting module is configured for controlling the intensity of light from the light emitting module.

5. The photoelectrochemical assay apparatus of claim 1, wherein the length of nanotube of the titanium dioxide nanotube arrays electrode is ranged from 1800 nm to 2300 nm.

6. The photoelectrochemical assay apparatus of claim 1, wherein the voltage is ranged from 0 V to 1 V.

7. The photoelectrochemical assay apparatus of claim 1, wherein an intensity of light from the light emitting module is ranged from 10 mW/cm² to 30 mW/cm².

8. The photoelectrochemical assay apparatus of claim 1, wherein the distance is ranged from 0.5 cm to 2.0 cm.

9. The photoelectrochemical assay apparatus of claim 1, wherein the titanium dioxide nanotube arrays electrode is prepared by performing an anodic oxidation on titanium, and the electrolytes for the anodic oxidation comprising an ammonium fluoride, a hydrogen fluoride, a glycerol or a glycol.

10. The photoelectrochemical assay apparatus of claim 1, wherein a weight percentage of the glycerol in the electrolytes is ranged from 50% to 80%.

11. The photoelectrochemical assay apparatus of claim 1, wherein the measuring cell comprises a batch reactor or a continuous flow reactor.
